(19) United States
(12) Patent Application Publication
(10) Pub. No.: US 2010/0007576 A1
(43) Pub. Date: Jan. 14, 2010

(54) Handheld Electronic Devices with Moveable Displays and Dynamic Display Control

(75) Inventors: Randolph Cary Demuynck, Wake Forest, NC (US); Charles C. Hunt, Wake Forest, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB, Lund (SE)

(21) Appl. No.: 12/172,451

(22) Filed: Jul. 14, 2008

(51) Int. Cl. G09G 5/00

(52) U.S. Cl. 345/1.3

(57) ABSTRACT

A handheld electronic device, such as a mobile terminal, PDA, media player or the like, includes a plurality of displays including at least one display moveable to variably overlap at least one other of the plurality of displays. A position sensor circuit is operatively associated with the at least one moveable display and is configured to detect movement thereof. A display controller circuit is configured to control respective images displayed on the plurality of the displays responsive to the position sensor circuit.

### FIELD OF THE INVENTION

The present invention relates to handheld electronic devices and, more particularly, to handheld electronic devices with display capabilities.

### BACKGROUND OF THE INVENTION

Consumers may now select from a wide array of handheld electronic devices, such as cellular mobile terminals, personal digital assistants (PDAs) and media players. Such devices typically provide audio and/or video user interfaces. For example, a mobile terminal may include a display, keypad, speaker and microphone, which together support telephony functions. These components may also Support multimedia, gaming and other applications.

Producers of such devices constantly strive to provide new audio and visual interfaces to enhance user experience and, thus, gainer greater market share. Thus, for example, handheld devices have been provided with touchscreen displays that allow for user scrolling and other inputs, and display generators that use accelerometer inputs to adaptively onent an image to adjust for the attitude at which the device is being held. For example, Apple Incorporated's iPhone changes its display between portrait and landscape modes responsive to an accelerometer that senses the attitude at which the device is being held.

### SUMMARY OF THE INVENTION

In some embodiments of the present invention, a handheld electronic device, such as a mobile terminal, PDA, media player or the like, includes a plurality of displays including at least one display moveable to variably overlap at least one other of the plurality of displays. A position sensor circuit is operatively associated with the at least one moveable display and is configured to detect movement thereof. A display controller circuit is configured to control respective images displayed on the plurality of the displays responsive to the position sensor circuit.

For example, in some embodiments, the plurality of displays may include first and second displays fixed in or deployable to a side-by-side arrangement and the at least one moveable display may include a third display fixed in or deployable to an overlapping arrangement with respect to the first and second displays in the side-by-side arrangement. Display surfaces of the first and second displays may lie in a first plane in the side-by-side arrangement and the third display may be fixed in or deployable to an overlapping arrangement with respect to the first and second displays in the side-by-side arrangement such that a display surface of the third display lies in a second plane parallel to the first plane.

According to further embodiments, the third display is moveable among a first position in which the third display predominantly overlaps the first display, a second position in which the third display overlaps portions of the first and second displays and a third position in which the third display predominantly overlaps the second display. The display controller circuit may be configured to display a composite image of a single scene across the first, second and third displays responsive to detecting movement of the third display to the second position. The device may further include a user input device, such as a touchscreen, that is configured to accept a user input and the display controller circuit may be operatively coupled to the user input device and further configured to transition one of the first, second and third displays from display of a portion of the composite image to display of a discrete image responsive to the user input. The display controller circuit may be further configured to transition from display of the composite image to display of respective first and second discrete images on the second and third displays responsive to detection of movement of the third display from the second position to the third position.

In additional embodiments of the present invention, a handheld electronic device includes a clamshell housing including first and second portions joined by a hinge that supports movement of the housing between an open position and a closed position. Respective first and second displays are mounted on the first and second portions of the clamshell housing such that the first and second displays are opposed when the clamshell housing is in the closed position and such that the first and second displays are deployed in a side-by-side configuration when the clamshell housing is in the open position. A third display is mounted on the clamshell housing and configured to move across the first and second displays to variably overlap the first and second displays. A position sensor circuit is configured to detect movement of the third display with respect to the first and second displays, and a display controller circuit is configured to control respective images displayed on the first, second and third displays responsive to the position sensor circuit. Display surfaces of the first and second displays may lie in a first plane when the clamshell housing is in the open position and a display surface of the third display may lie in a second parallel plane overlying the first plane when the clamshell housing is in the open position.

When the clamshell housing is in the open position, the third display may be moveable among a first position in which the third display predominantly overlaps the first display, a second position in which the third display overlaps portions of the first and second displays and a third position in which the third display predominantly overlaps the second display. The display controller circuit may be configured to display a composite image of a single scene across the first, second and third displays responsive to detecting movement of the third display to the second position. The device may further include a user input device configured to accept a user input and the display controller circuit may be operatively coupled to the user input device and further configured to transition one of the first, second and third displays from display of a portion of the composite image to display of a discrete image responsive to the user input. The display controller circuit may be further configured to transition from display of the composite image to display of respective first and second discrete images on the second and third displays responsive to detection of movement of the third display from the second position to the third position. The position sensor circuit may include a first set of electrical contacts configured to move with the third display and variably engage a second set of contacts fixedly positioned with respect to the first and second displays.

Still further embodiments of the present invention provide methods of operating a handheld electronic device including a plurality of displays including at least one display moveable to variably overlap at least one other of the plurality of displays. Movement of the at least one moveable display is detected and display of respective images on the plurality of the displays is controlled responsive to the detected movement.

Other electronic devices and/or methods according to embodiments of the invention will be or become apparent to one with skill in the art upon review of the following drawings and detailed description. It is intended that all such additional electronic devices and methods be included within this description, be within the scope of the present invention, and be protected by the accompanying claims.

### BRIEF DESCRIPTION OF THE DRAWINGS

FIGS. 1-3 illustrate a mobile terminal according to some embodiments of the present invention.

FIG. 4 is a schematic diagram that illustrates apparatus and operations for dynamic display control according to some embodiments of the present invention.

FIG. 5 is a schematic diagram illustrating apparatus and operations for dynamic display control in a mobile terminal according to further embodiments of the present invention.

FIGS. 6A-6E illustrate dynamic display control in a mobile terminal according to some embodiments of the present invention.

FIG. 7 is a schematic diagram illustrating a display set including a moveable display according to some embodiments of the present invention.

FIGS. 8A-8C illustrate detection of position of a moveable display for the displays of FIG. 7.

FIG. 9 is a schematic diagram illustrating fixed displays for use with a moveable display according to further embodiments of the present invention.

FIGS. 10A-10I illustrate detection of relative position of a moveable display with respect to the displays of FIG. 9.

FIG. 11 illustrates a display controller circuit configured to control a display responsive to varying voltage inputs applied to a set of spaced-apart contacts according to some embodiments of the present invention.

FIG. 12 illustrates state transitions of a display controller circuit according to some embodiments of the present invention.

### DETAILED DESCRIPTION OF EMBODIMENTS OF THE INVENTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Some embodiments are described with regard to flowcharts in which each block represents a circuit element, module, or portion of code which includes one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Some embodiments of the present invention arise from a realization that an improved user interface for a handheld electronic device may use a set of overlapping displays including a moveable display that may be variably overlapped across one or more other displays to support, for example, a mode in which the moveable and fixed displays present components of a composite image having a size greater than any of the individual displays. For example, a “clamshell” device, such as a mobile terminal, may include first and second displays fixedly mounted on respective portions of a hinged clamshell housing and a third, moveable display that is configured to slide across the two fixed displays when the clamshell housing is in an open position. When this moveable display is moved over the hinge to bridge across the other two displays, the displays may change their displayed images, for example, to transition from a telephone interface mode in which each display presents a discrete image to a widescreen multimedia mode in which the displays collectively provide a composite image.

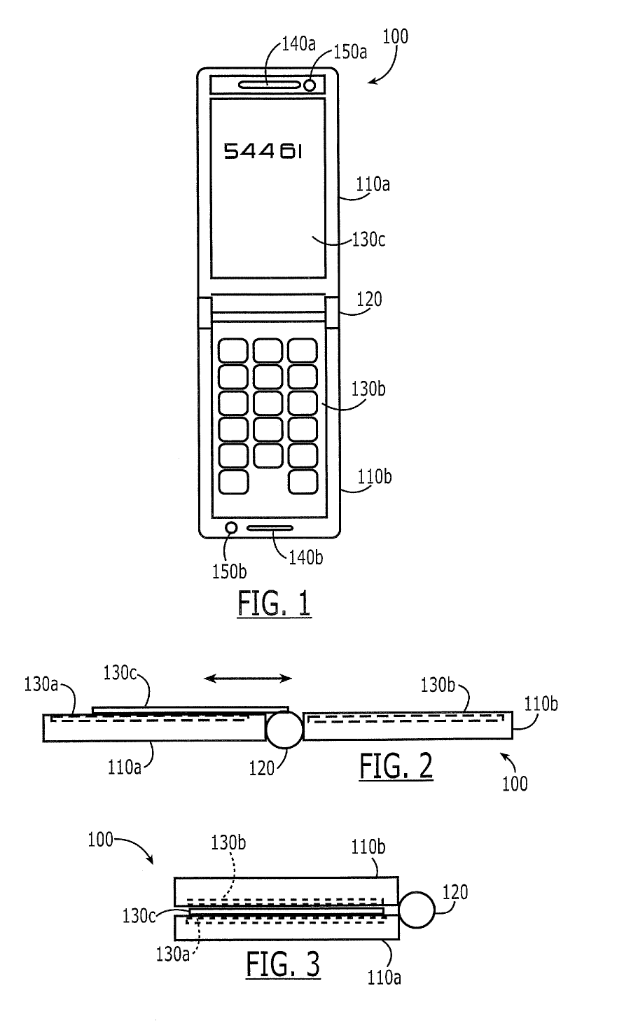

FIGS. 1-3 illustrate a mobile terminal 100 according to some embodiments of the present invention. The mobile terminal 100 has a clamshell housing including housing portions 110a, 110b connected by a hinge 120. Speakers 140a, 140b and microphones 150a, 150b are positioned on respective ones of the clamshell housing portions 110a, 110b. First and second displays 130a, 130b are fixedly mounted on respective ones of the clamshell housing portions 110a, 110b, such that the displays 130a, 130b are arranged side-by-side when the mobile terminal 100 is in an open position, as shown in FIG. 2, and such that the displays 130a, 130b are opposed when the mobile terminal 100 is in a closed position, as shown in FIG. 3. As illustrated, the displays 130a, 130b may be touch-sensitive displays that are further configured to accept user inputs.

As further shown, the mobile terminal 100 includes a third, moveable display 130c that is configured to variably overlap the first and second displays 130a, 130b. In particular, as shown in FIG. 3, when the mobile terminal 100 is in the closed position, the moveable display 130c may be positioned overlapping either one of the fixed displays 130a, 103b, such that the moveable display 130c is sandwiched between the two fixed displays 130a, 130b. When the mobile terminal 100 is in the open position, as shown in FIG. 2, the moveable display 130c may be free to slide across the hinge 120 to variably overlap the two fixed displays 130a, 130b.

It will be appreciated that movement of the moveable display 130c may be achieved in any of a number of different ways. For example, the moveable display 130c may have a tab or other feature that a user may engage to push the moveable display 130c across the fixed displays 130a, 103b. The moveable display 130c may also be moved using a mechanical or electromechanical actuator, such as a spring loaded actuator or motor drive.

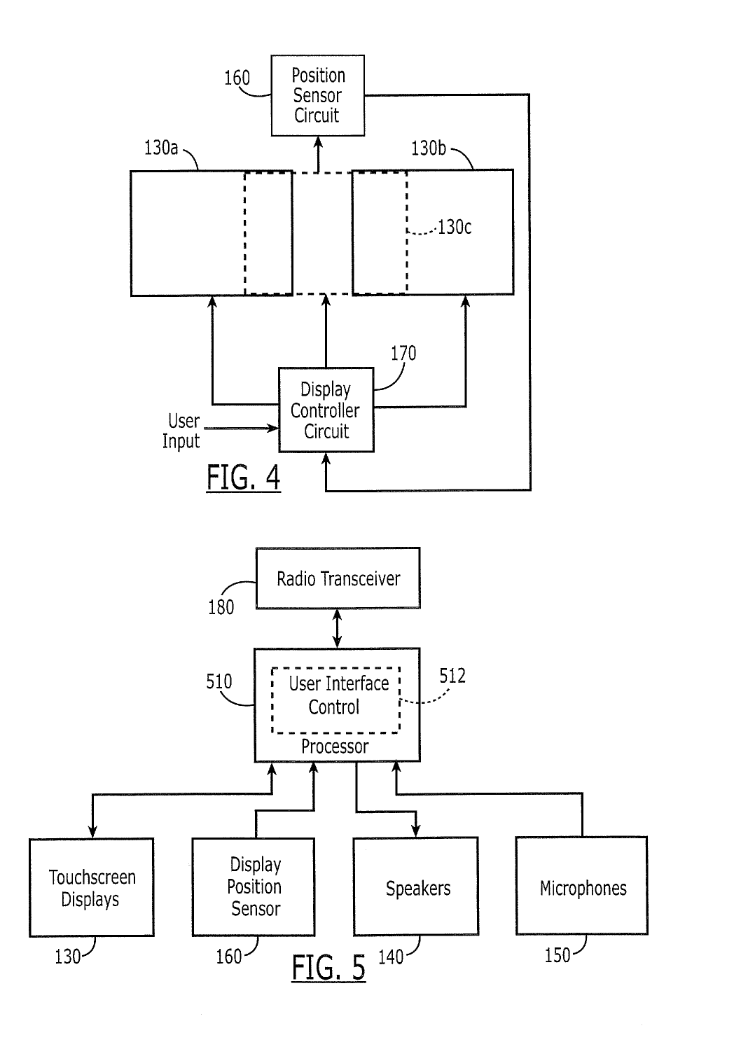

According to some embodiments of the present invention, images presented by the displays 130a, 130b, 130c may be controlled responsive to the position of the moveable display 130c in relation to the fixed displays 130a, 130b. For example, as shown in FIG. 4, the mobile terminal 100 may include a position sensor circuit 160 that is configured to generate a position sensor signal that is indicative of a relative position of the moveable display 130c with respect to the fixed displays 130a, 131b. The position sensor circuit 160 may include any of a number of different types of sensor devices, including, but not limited to electrical contacts, potentiometers, magnetic sensors and capacitive sensors. A display controller circuit 170 may be configured to receive the position sensor signal and to control display of images on the displays 130a, 130b, 130c responsive thereto. The display controller circuit 170 may be further configured to control images on the displays 130a, 130b, 130c responsive to user inputs. For example, the displays 130a, 130b, 130c may be touchscreen displays that may be used to accept the user inputs and/or user inputs may be provided using other devices, such as keys or joysticks.

FIG. 5 is a schematic diagram illustrating an exemplary implementation for the mobile terminal 100 of FIG. 1. The mobile terminal 100 includes a radio transceiver 180, touchscreen displays 130, speakers 140, microphones 150 and a display position sensor 160. The mobile terminal 100 further includes a processor 510 (e.g., a microcontroller or microprocessor and associated peripheral circuitry, such as memory, input/output circuitry, audio circuits, display driver circuits and the like) that is operatively associated with the displays 130, speakers 140, microphones 150, display position sensor 160 and radio transceiver 180. The processor 510 may execute program code that is configured to create a user interface control function 512 that controls the displays 130, speakers 140 and microphones 150. In particular, the user interface control function 512 may be configured to control image presentation on the displays 130 responsive to a position sensor signal provided by the display position sensor 160, along the lines discussed above with reference to FIG. 4.

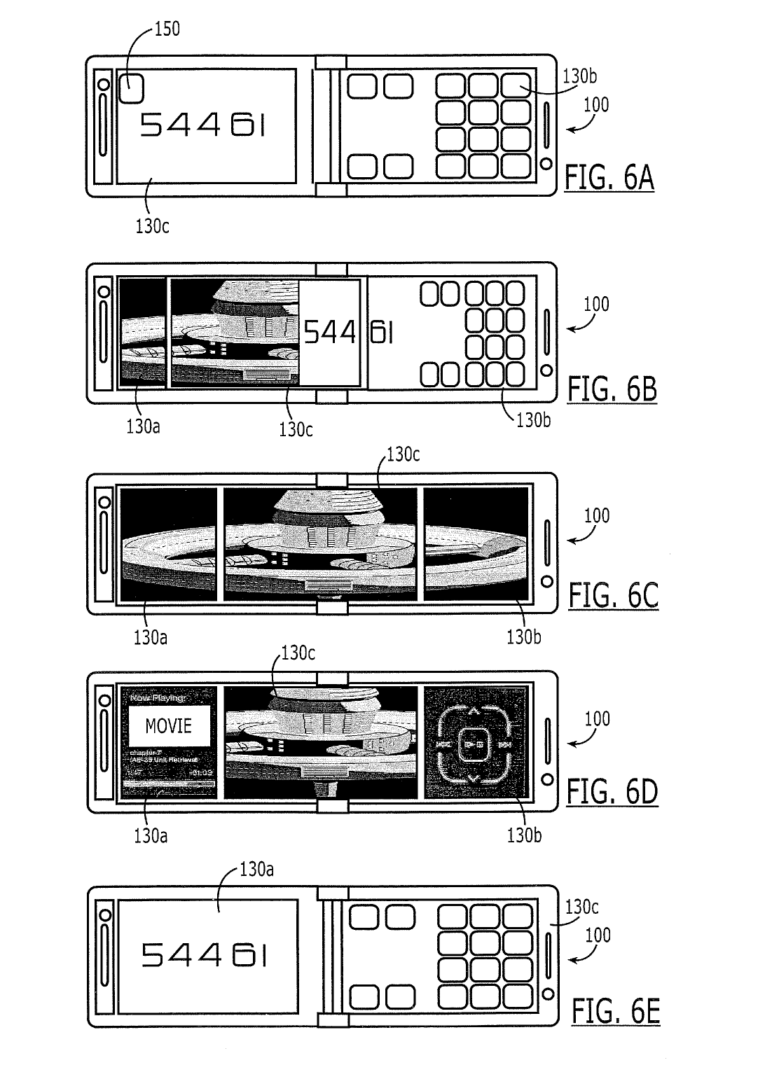

FIGS. 6A-6E illustrate an example of such display control. Referring to FIG. 6A, when the moveable display 130c is in a first position predominantly overlapping the first fixed display 130a, the moveable display 130c and the non-occluded fixed display 130b are used to show respective images supporting a telephone user interface, e.g., a keypad image is displayed on the fixed display 130b and an informational image is displayed on the moveable display 130c. A tab 150 is included in the image on the moveable display 130c, indicative of the presence of an underlying alternative image (in the illustrated case, a video) that may be accessed responsive to movement of the moveable display 130c.

Referring to FIG. 6B, as the user begins to move the moveable display 130c to reveal a portion of the underlying fixed display 130a, a video image begins to be “previewed” on the fixed display 130a and the moveable display 130c, while portions of the telephone interface image “slide” onto the other fixed display 130b. When the moveable display 130c is moved to a centered detent position as shown in FIG. 6C, the video image is displayed in composite across the two fixed displays 130a, 130b and the centered moveable display 130c, thus providing a widescreen image. As shown in FIG. 6D, a user input to one or more of the displays 130a, 130b, 130c may cause the displays 130a, 130b, 130c to transition to a new display mode in which display of the video is limited to the center display 130c, and the outboard displays 130a, 130b provide information and/or user control images. As shown in FIG. 6E, sliding the moveable display 130c all the way to a right detent position causes reversion to a telephone user interface image, this time with the moveable display 130c providing a keypad image and the left display 130a providing an informational image.

It will be appreciated that a variety of other display movement controlled display transitions may be provided in further embodiments of the present invention. For example, instead of providing mirror image displays in the far left and far right detent positions of the moveable display 103c, these positions may be used to display different user interface image sets, such as different telephone user interface images or a telephone interface image and a music player interface image, respectively. Instead of triggering a composite display as shown in FIG. 6C, movement of the moveable display 130c to the center position could trigger display of a video selection interface, in which a user could select a video for presentation, followed by transition to display of the selected video in the widescreen mode shown in FIG. 6C.

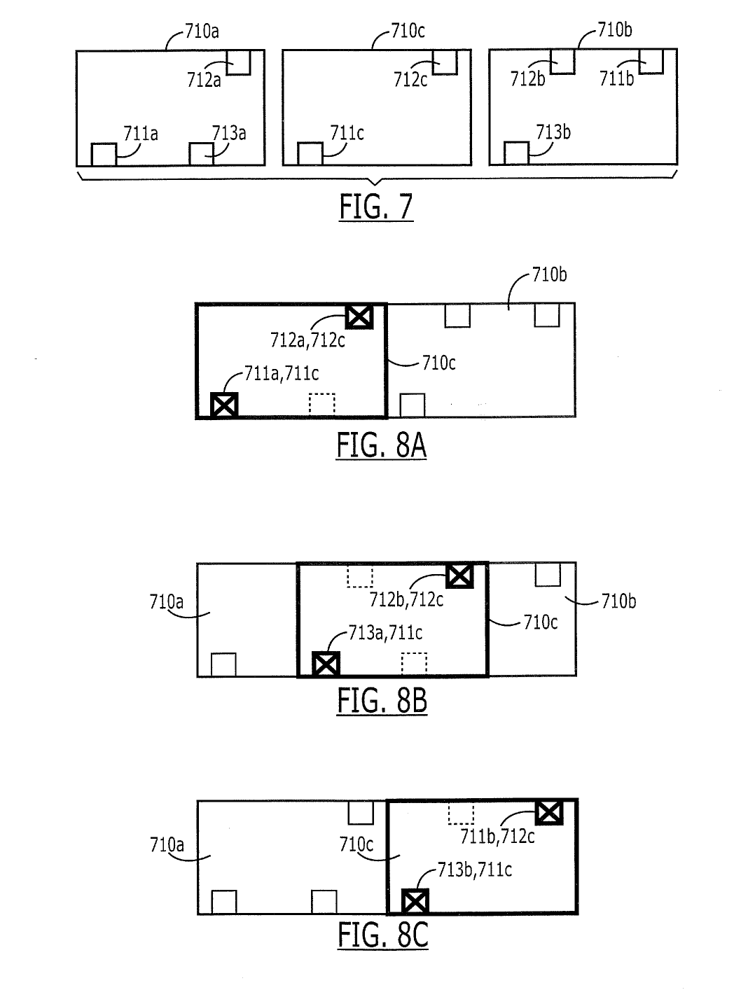

A variety of techniques may be used for sensing screen position, including using sets of contacts and/or resistive, capacitive or magnetic transducers. For example, as shown in FIG. 7, first and second fixed displays 710a, 710b may have a first set of contacts 711a, 712a, 713b and a second set of contacts 711b, 712b, 713b associated therewith. It will be appreciated that such contacts may be positioned on the displays or at fixed positions with respect thereto. A third moveable display 710c includes another set of contacts 711c, 712c that are configured to variably engage the contacts associated with the fixed displays 710a, 710b. In particular, as shown in FIG. 5A, when the moveable display 710c overlies the first fixed display 710a in first position, contacts 711a, 712a of the fixed display 710a engage the contacts 711c, 712c of the moveable display 710c. As shown in FIG. 8B, when the moveable display 710c is moved to a second position in which it substantially equally overlaps each of the fixed displays 710a, 710b the contacts 710c, 712c of the moveable display 710c engage the contact 713a of the first display 710a and the contact 712b of the second display, respectively. Referring to FIG. 5C, in a third position in which the moveable display 710c overlaps the second fixed display 710b, contacts 711c, 712c of the moveable display 710c engage contacts 713, 711b of the fixed display 710b. As these connection patterns are unique, these three positions can be discriminated for use in display control.

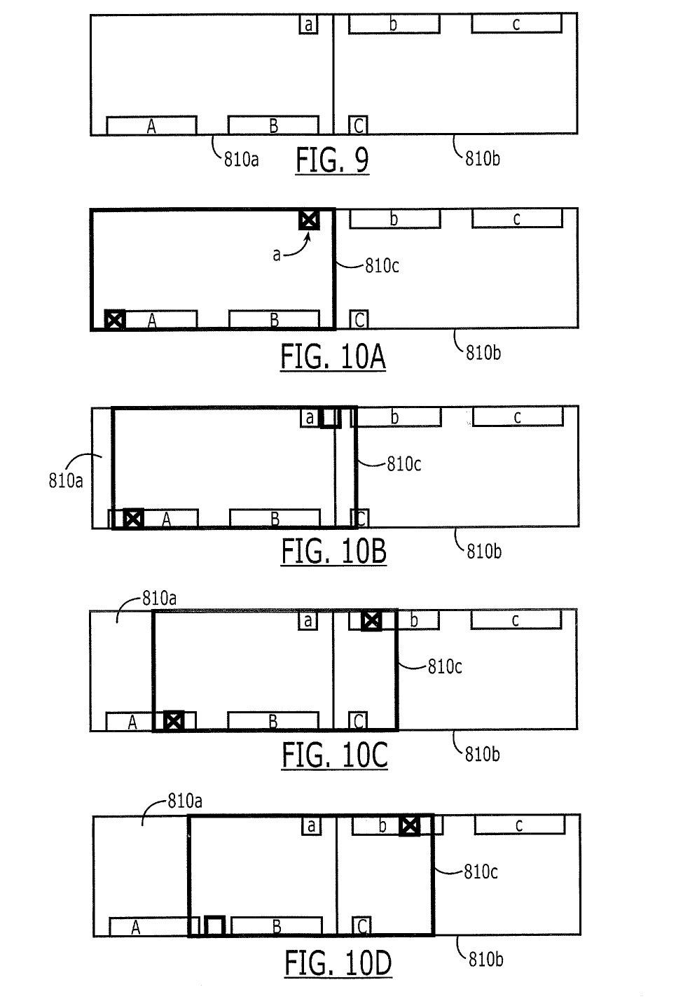

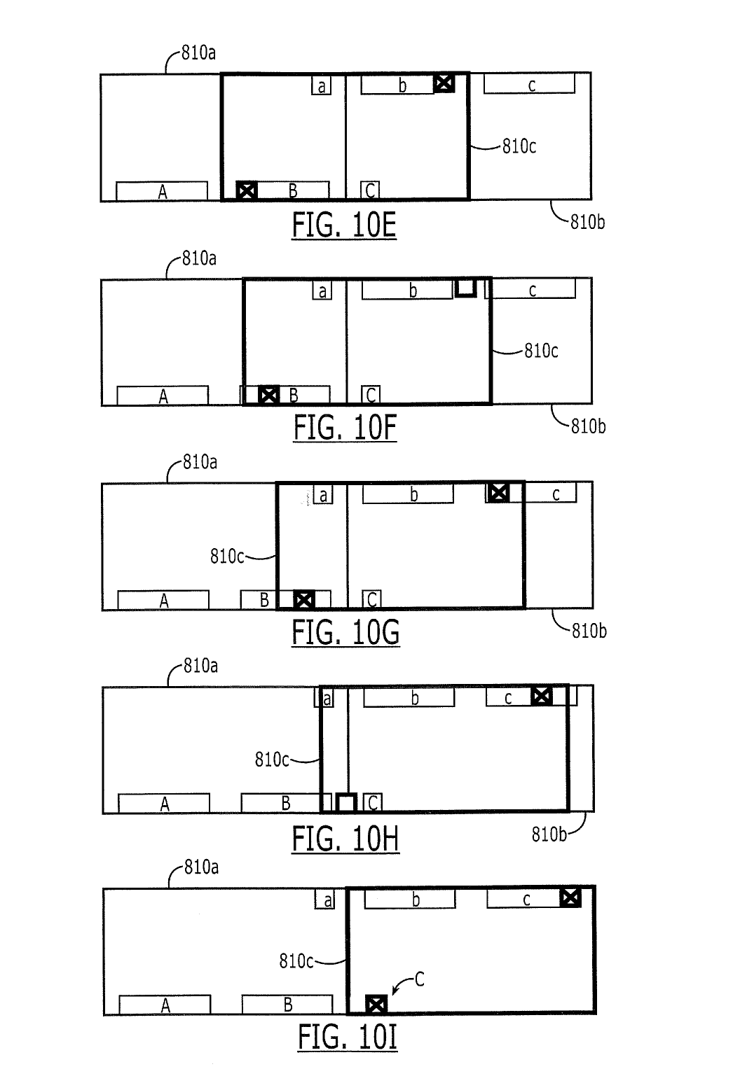

According to further embodiments, a position sensor for a moveable display may further support determination of direction of movement of a display to support, for example, intermediate modes such as the “preview” move shown in FIG. 6B. For example, referring to FIG. 9, fixed displays 810a, 810b may have contacts “A”, “B”, “C”, “a”, “b”, “c ” associated therewith. Referring to FIG. 10A, a moveable display 810c has a set of contacts that are configured to engage the fixed contacts “A”, “B”, “C”, “a”, “b” , “c”. As shown in FIGS. 10A-10I, as the moveable display 810c moves from left to right, a pattern of connections between the contacts of the moveable display and the fixed contacts “A”, “B”, “C”, “a”, “b”, “c” occurs that can be used to discern the direction of movement. In particular, in the position shown in FIG. 10A, the contacts of the moveable display 810c engage contacts “A” and “a”. As the moveable display 810c is moved right to the position shown in FIG. 10B, contact is lost with contact “a” while contact remains with contact “A”. Moving further right, contacts “A” and “b” are next engaged, as shown in FIG. 10C. As shown in FIG. 10D, movement further right leads to loss of contact with contact “A”, while contact remains with contact “b”.

When the moveable display 810c reaches a middle position as shown in FIG. 10E, the contacts of the moveable display 810c engage contacts “B” and “b”. Moving still farther right leads to loss of contact with contact “b” as shown in FIG. 10F. As shown in FIG. 10G, movement further right leads to engagement of contact “c”, followed by loss of contact with contact “B” as shown in FIG. 10H. Finally, upon movement of the moveable display 810c to the farthest right position, the contacts of the moveable display 810c engage contacts “C” and “c”.

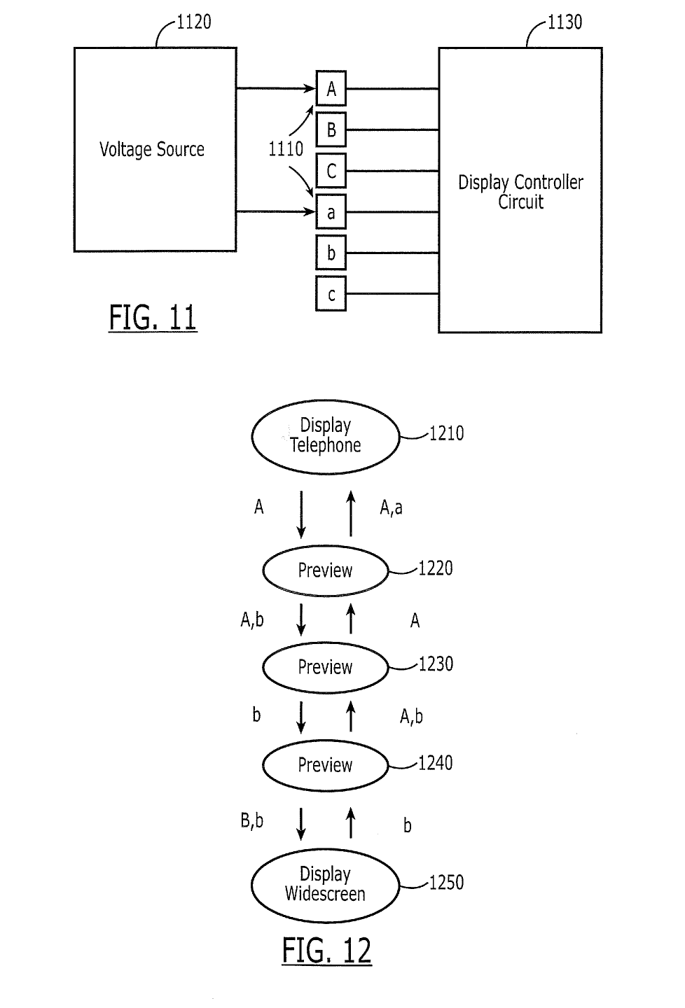

FIGS. 11 and 12 illustrate how contacts along the lines shown in FIG. 10 may be used to control state transitions of a display controller circuit. As shown in FIG. 11, contacts 1110 of the moveable display may be connected to a voltage source 1120 (e.g., a 5 volt source). A display controller circuit 1130 senses application of the voltage source 1120 via the moving contacts 1110 to the fixed contacts “A”, “B”, “C”, “a“, “b”, “c” and uses the voltage at the fixed contacts “A”, “B”, “C”, “a”, “b”, “c” as inputs to a state machine. For example, as shown in FIG. 12, while in a far left detent state 1210, the display controller circuit 1130 senses a transition from presence of the voltage at contacts “A” and “a” to presence of the voltage only at the contact “a”, and transitions from a “Display Telephone” state 1210 to a “Preview” state 1220, along lines discussed above with reference to FIG. 6B. Responsive to detecting a transition from the presence of the voltage at only the contact “A” to presence of the voltage at contacts “A” and “b”, the display controller circuit 1130 transitions to another “Preview” state 1230, which may result, for example, in presentation of a modified preview image. Responsive to detecting a transition from the presence of the voltage at the contacts “A” and “b” to presence of the voltage only at the contact “b”, the display controller circuit 1130 transitions to yet another “Preview” state 1240. Responsive to detecting a transition from the presence of the voltage at only at the contact “b” to the presence of the voltage at contacts “B” and “b”, the display controller circuit 1130 transitions to a “Display Widescreen” state 1250 along the lines discussed above with reference to FIG. 6C. These state transitions may be reversed with movement in the opposite direction.

It will be appreciated that the contact-based techniques for position detection illustrated in FIGS. 7-12 are provided for purposes of illustration and that a variety of other position sensing technique may be used with the present invention. For example, display position may be sensed using a voltage divider circuit including a potentiometer (e.g., a resistive strip and wiper) or by circuits employing capacitive or magnetic sensors. Such sensors may measure position with respect to any of a number of different points of references, for example, with respect to certain features of the device, such as the hinge 120 shown in FIGS. 1-3. It will be further appreciated that, although embodiments employing a single display that moves with respect to two fixed displays are shown, other embodiments of the present invention may use more than one moveable display and/or more or fewer fixed displays, as well as displays that have different relative movements. It will also be understood that, although embodiments in a mobile terminal application are illustrated, other embodiments may be implemented in other types of handheld devices, such as PDA's or media players.

In the drawings and specification, there have been disclosed exemplary embodiments of the invention. However, many variations and modifications can be made to these embodiments without substantially departing from the principles of the present invention. Accordingly, although specific terms are used, they are used in a generic and descriptive sense only and not for purposes of limitation, the scope of the invention being defined by the following claims.

That which is claimed:

1. A handheld electronic device comprising:
a plurality of displays including at least one display moveable to variably overlap at least one other of the plurality of displays;
a position sensor circuit operatively associated with the at least one moveable display and configured to detect movement thereof, and
a display controller circuit configured to control respective images displayed on the plurality of the displays responsive to the position sensor circuit.

2. The device of claim 1, wherein the plurality of displays comprises first and second displays fixed in or deployable to a side-by-side arrangement and wherein the at least one moveable display comprises a third display fixed in or deployable to an overlapping arrangement with respect to the first and second displays in the side-by-side arrangement.

3. The device of claim 2, wherein display surfaces of the first and second displays lie in a first plane in the side-by-side arrangement and wherein the third display is fixed in or deployable to an overlapping arrangement with respect to the first and second displays in the side-by-side arrangement such that a display surface of the third display lies in a second plane parallel to the first plane.

4. The device of claim 2, wherein the third display is moveable among a first position in which the third display predominantly overlaps the first display, a second position in which the third display overlaps portions of the first and second displays and a third position in which the third display predominantly overlaps the second display.

5. The device of claim 4, wherein the display controller circuit is configured to display a composite image of a single scene across the first, second and third displays responsive to detecting movement of the third display to the second position.

6. The device of claim 5, further comprising a user input device configured to accept a user input and wherein the display controller circuit is operatively coupled to the user input device and further configured to transition one of the first, second and third displays from display of a portion of the composite image to display of a discrete image responsive to the user input.

7. The device of claim 6, wherein the user input device comprises a touchscreen sensor of at least one of the first, second and third displays.

8. The device of claim 5, wherein the display controller circuit is configured to transition from display of the composite image to display of respective first and second discrete images on the second and third displays responsive to detection of movement of the third display from the second position to the third position.

9. A handheld electronic device comprising:
a clamshell housing comprising first and second portions joined by a hinge that supports movement of the housing between an open position and a closed position;
respective first and second displays mounted in the first and second portions of the clamshell housing such that the first and second displays are opposed when the clamshell housing is in the closed position and such that the first and second displays are deployed in a side-by-side configuration when the clamshell housing is in the open position;
a third display mounted on the clamshell housing and configured to move across the first and second display to variably overlap the first and second displays;
a position sensor circuit configured to detect movement of the third display with respect to the first and second displays; and
a display controller circuit configured to control respective images displayed on the first, second and third displays responsive to the position sensor circuit.

10. The device of claim 9, wherein display surfaces of the first and second displays lie in a first plane when the clamshell housing is in the open position and wherein a display surface of the third display lies in a second parallel plane overlying the first plane when the clamshell housing is in the open position.

11. The device of claim 10, wherein, when the clamshell housing is in open position, the third display is moveable among a first position in which the third display predominantly overlaps the first display, a second position in which the third display overlaps portions of the first and second displays and a third position in which the third display predominantly overlaps the second display.

12. The device of claim 11, wherein the display controller circuit is configured to display a composite image of a single scene across the first, second and third displays responsive to detecting movement of the third display to the second position.

13. The device of claim 12, further comprising a user input device configured to accept a user input and wherein the display controller circuit is operatively coupled to the user input device and further configured to transition one of the first, second and third displays from display of a portion of the composite image to display of a discrete image responsive to the user input.

14. The device of claim 13, wherein the user input device comprises a touchscreen sensor of at least one of the first, second and third displays.

15. The device of claim 12, wherein the display controller circuit is configured to transition from display of the composite image to display of respective first and second discrete images on the second and third displays responsive to detection of movement of the third display from the second position to the third position.

16. The device of claim 9, wherein the position sensor circuit comprises a first set of electrical contacts configured to move with the third display and variably engage a second set of contacts fixedly positioned with respect to the first and second displays.

17. A method of operating a handheld electronic device comprising a plurality of displays including at least one display moveable to variably overlap at least one other of the plurality of displays, the method comprising:
detecting movement of the at least one moveable display with respect to the at least one other display; and
controlling images displayed on the plurality of the displays responsive to the detected movement.

18. The method of claim 17:
wherein the plurality of displays comprises first and second displays fixed in or deployable to a side-by-side arrangement and wherein the at least one moveable display comprises a third display fixed in or deployable to an overlapping arrangement with respect to the first and second displays in the side-by-side arrangement;
wherein detecting movement of the at least one moveable display with respect to the at least one other display comprises detecting movement from a first position in which the third display predominantly overlaps the first display to a second position in which the third display overlaps portions of the first and second displays; and
wherein controlling respective images displayed on the plurality of the displays responsive to the detected movement comprises displaying a composite image of a single scene across the first, second and third displays responsive to detecting movement of the third display to the second position.

19. The method of claim 18:
wherein detecting movement of the at least one moveable display with respect to the at least one other display further comprises detecting movement of the third display from the second position to a third position in which the third display predominantly overlaps the second display; and
wherein controlling respective images displayed on the plurality of the displays responsive to the detected movement further comprises transitioning from display of the composite image to display of respective first and second discrete images on the second and third displays responsive to detection of movement of the third display from the second position to the third position.
